(19) United States
(12) Patent Application Publication
(10) Pub. No.: US 2026/0264588 A1
(43) Pub. Date: Sep. 10, 2026

(54) HEATER DEVICE AND VEHICLE SEAT

(71) Applicant: NHK SPRING CO., LTD., Yokohama-shi, Kanagawa (JP)

(72) Inventors: Jun TOKUSHIGE, Yokohama-shi, Kanagawa (JP); Yuto TSUDA, Yokohama-shi, Kanagawa (JP); Donghyoun KIM, Yokohama-shi, Kanagawa (JP); Ryota TAKATSUKI, Yokohama-shi, Kanagawa (JP)

(21) Appl. No.: 19/140,915

(22) PCT Filed: Dec. 19, 2023
(86) PCT No.: PCT/JP2023/045538

§ 371 Date: May 14, 2026

(30) Foreign Application Priority Data
Dec. 23, 2022 (JP) 2022-207317

(51) Int. Cl. B60N 2/56; H05B 3/20

(52) U.S. Cl. CPC B60N 2/5685; H05B 3/20; B60N 2220/00

(57) ABSTRACT

When a heating abnormality has occurred in a planar heating element, the present disclosure contributes to preventing the abnormality from being left unattended.

A heater device (20) includes a planar heating element (22A, 22B, 22C) including a heating layer 26 in which a carbon material is uniformly dispersed, a detection unit that is configured to detect a heating abnormality of the planar heating element (22A, 22B, 22C), and a notification unit that uses a mobile terminal (32) and a display (34) to notify a user of the abnormality in a case in which an abnormality has been detected by the detection unit.

### TECHNICAL FIELD

The present disclosure relates to a heater device equipped with a planar heating element including a heating layer in which a carbon material is uniformly dispersed, and to a vehicle seat equipped with such a heater device.

### BACKGROUND ART

A heater drive device disclosed in Japanese Patent Application Laid-Open (JP-A) No. 2021-51984 functions as a power supply control device, and controls power supply to an electrical heating wire. In such a heater drive device, a current output circuit and a detection resistance function as a current detection unit to detect current flowing in the electrical heating wire. A microcomputer repeatedly computes a heating wire temperature related to the electrical heating wire based on the current that has been detected. A drive circuit functions as a switching unit able to switch a switch ON or OFF according to the computed heating wire temperature. The configuration accordingly maintains the heating wire temperature at an appropriate temperature without arranging a temperature detection element in the vicinity of the electrical heating wire.

### SUMMARY OF INVENTION

### Technical Problem

When a heater device includes an electrical heating wire, as in the related art described above, current no longer flows if there is a break in the heating wire, and so abnormal heating does not occur. However, in a heater device equipped with a planar heating element including a heating layer in which a carbon material is uniformly dispersed (for example, a carbon nanotube film heater), even when damage has occurred to part of the planar heating element, current still flows through undamaged portions. There is accordingly a possibility that abnormal heating occurs at the edges of the damaged locations, and depending on the degree and position of damage, sometimes the portion where there is abnormal heating is small and a normal temperature is maintained in other portions thereof. In such cases inconvenience is caused to a user if usage of the heater device is immediately stopped. The function of a heater is necessary, particularly in cold regions, and so continuing to use the heater device is preferable within safe limits, however there is a need to prevent abnormalities from being left unattended to.

In consideration of the above circumstances, an object of the present disclosure is to obtain a heater device that contributes to the prevention of an abnormality from being left unattended when a heating abnormality has occurred with a planar heating element, and to a vehicle seat equipped with the same.

### Solution to Problem

A heater device of a first aspect includes: a planar heating element including a heating layer in which a carbon material is uniformly dispersed; a detection unit configured to detect a heating abnormality of the planar heating element; and a notification unit that, in a case in which an abnormality has been detected by the detection unit, notifies a user of the abnormality using a user interface.

Note that the “carbon material” of the first aspect encompasses carbon nanotubes, carbon fibers, carbon black, graphene, and the like.

In the heater device of the first aspect, the planar heating element includes the heating layer in which a carbon material is uniformly dispersed. In a case in which part of the planar heating element is damaged and a heating abnormality occurs in this part, the abnormality is detected by the detection unit, and also the notification unit uses the user interface to notify a user of the abnormality. This thereby enables prompting of the user to inspect and repair the heater device. This accordingly contributes to the prevention of an abnormality from being left unattended.

A heater device of a second aspect is the first aspect, wherein: the detection unit is configured to detect at least one out of an electrical resistance of the planar heating element, a voltage applied to the planar heating element, a current flowing in the planar heating element, or a temperature of the planar heating element; and the notification unit uses the user interface to notify a user of the at least one in a case in which an abnormality has been detected by the detection unit.

In the heater device of the second aspect, when at least one out of the electrical resistance of the planar heating element, the voltage applied to the planar heating element, the current flowing in the planar heating element, or the temperature of the planar heating element has been detected by the detection unit, the notification unit uses the user interface to notify a user of the at least one. This thereby enables the user to ascertain details about the abnormality of the planar heating element and, for example, facilitates the user guessing the cause of the abnormality.

A heater device of a third aspect is the first aspect or the second aspect, wherein the detection unit is configured to detect a degree of an abnormality based on an electrical resistance of the planar heating element, and the notification unit uses the user interface to notify the user of the degree of the abnormality in a case in which an abnormality has been detected by the detection unit.

In the heater device of the third aspect, the detection unit detects the degree of the heating abnormality of the planar heating element based on the electrical resistance of the planar heating element, and the notification unit notifies a user of the degree of abnormality using the user interface. This thereby enables the user to ascertain the degree of abnormality and so, for example, enables the user to determine whether or not there is a need to immediately repair the heater device.

A heater device of a fourth aspect is any one aspect of the first aspect to the third aspect, wherein: plural of the planar heating elements are provided; the detection unit is configured to individually detecting heating abnormalities of the plural planar heating elements; and the notification unit uses the user interface to individually notify the user of the abnormalities individually detected by the detection unit.

In the heater device of the fourth aspect, heating abnormalities of the plural planar heating elements are detected individually by the detection unit. The notification unit uses the user interface to individually notify the user of the abnormality individually detected by the detection unit. This thereby enables the user to ascertain whether an abnormality has occurred in which of the plural planar heating elements.

The vehicle seat of the fifth aspect includes: a seat main body including a seat cushion for an occupant of a vehicle to sit on and a seatback to support the back of the occupant; and the heater device of the first aspect to the fourth aspect having the planar heating element disposed in the seat main body.

In the vehicle seat of the fifth aspect, the seat main body includes the seat cushion for an occupant of a vehicle to sit on and the seatback to support the back of the occupant. The planar heating element of the heater device is disposed in the seat main body. The heater device is that of any one aspect from out of the first aspect to the fourth aspect, and so the advantageous effects described above are obtained.

As described above, when a heating abnormality has occurred in a planar heating element, the present disclosure contributes to preventing the abnormality from being left unattended.

### BRIEF DESCRIPTION OF DRAWINGS

FIG. 1 is a side view illustrating a vehicle seat according to an exemplary embodiment.

FIG. 2 is a block diagram illustrating part of a hardware configuration of a heater device according to an exemplary embodiment.

FIG. 3 is a block diagram illustrating part of a functional configuration of a control ECU provided to a heater device according to an exemplary embodiment.

FIG. 4 is a face-on view illustrating a configuration of a heater device equipped with a planar heating element according to an exemplary embodiment.

FIG. 5 is a flowchart illustrating an example of a flow of control processing executed by a control ECU of a heater device according to an exemplary embodiment.

### DESCRIPTION OF EMBODIMENTS

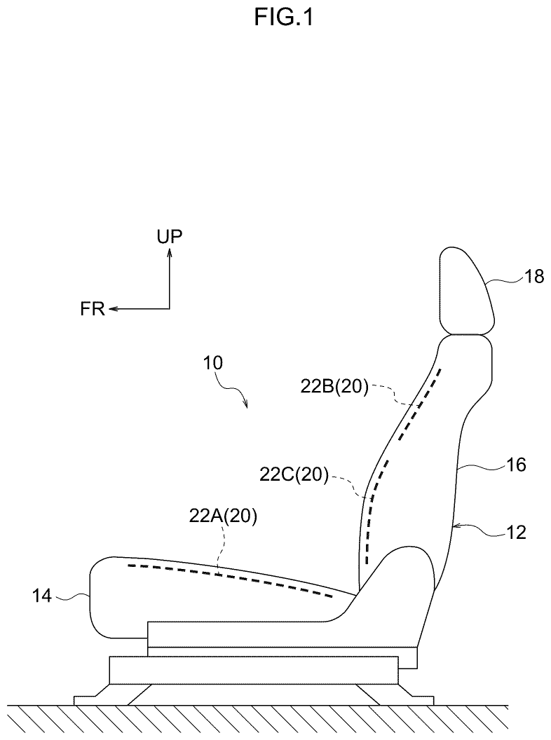

Description follows regarding a vehicle seat 10 according to an exemplary embodiment of the present disclosure, with reference to FIG. 1 to FIG. 5. Note that arrows FR and UP illustrated in FIG. 1 indicate forward and upward of the vehicle seat 10.

As illustrated in FIG. 1, the vehicle seat 10 according to the present exemplary embodiment is equipped with a seat main body 12 and a heater device 20. The seat main body 12 includes a seat cushion 14 for an occupant of a vehicle to sit on, a seatback 16 that supports the back of the occupant, and a headrest 18 that supports the head of the occupant. The occupant referred to above corresponds to a “user” of the present disclosure.

The seat cushion 14 includes a heater device 20 having a planar heater 22A disposed therein, and the seatback 16 includes heater devices 20 having planar heaters 22B, 22C disposed therein. The planar heater 22A is, for example, interposed between a cover of the seat cushion 14 and a pad member, and the planar heaters 22B, 22C are interposed between a cover of the seatback 16 and a pad member. The planar heaters 22A, 22B, 22C correspond to “planar heating elements” of the present disclosure.

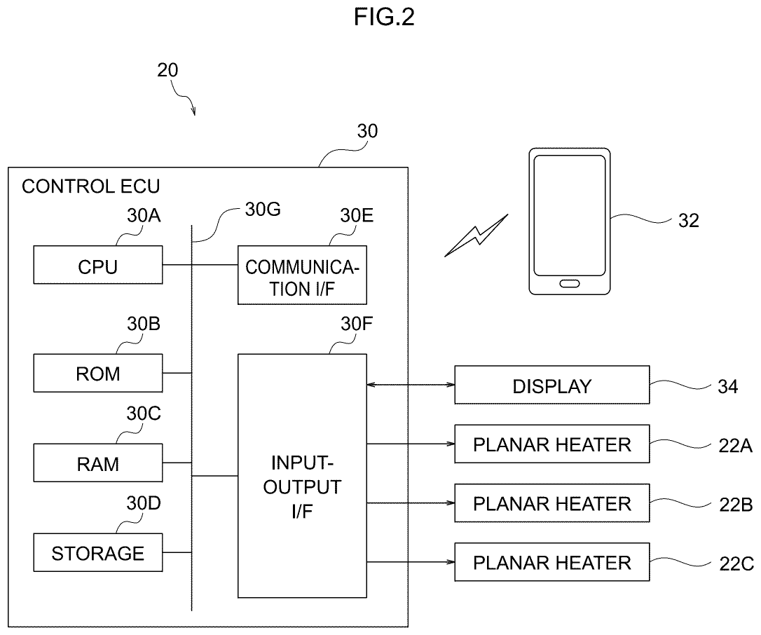

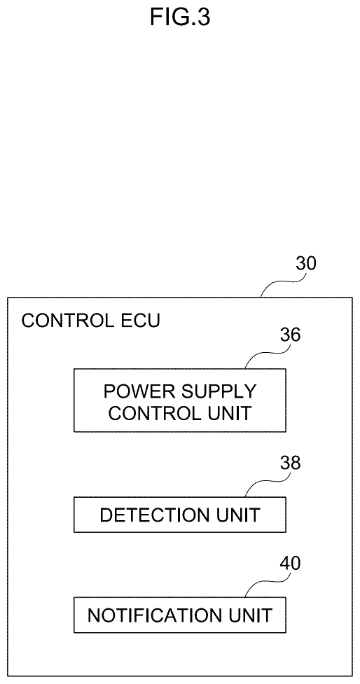

As illustrated in FIG. 2 and FIG. 3, in addition to the planar heaters 22A, 22B, 22C, the heater device 20 also includes a control ECU 30 (omitted in FIG. 1) that is a control unit. The planar heaters 22A, 22B, 22C include a heating layer 26 in which a carbon material is uniformly despersed.

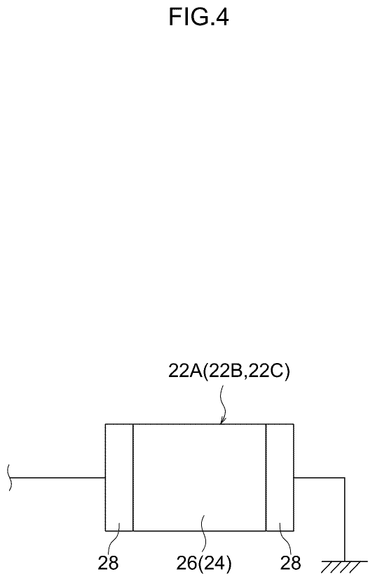

As illustrated in FIG. 4, the planar heaters 22A, 22B, 22C are carbon nanotube (CNT) film heaters that each include a carbon nanotube film 24 and a pair of electrodes 28. The carbon nanotube film 24 is, for example, configured by stacked layers of a substrate layer and an insulating layer (both omitted in the drawings), and the heating layer 26. The substrate layer and the insulating layer are, for example, configured in the form of a film or a cloth (including a non-woven fabric) from polyester, polyethylene, polyethylene terephthalate (PET), polyethylene naphthalate (PEN), polyurethane, polyimide, or polyamide. The heating layer 26 is, for example, configured by a coating membrane of carbon nanotubes formed on the substrate layer.

The carbon nanotubes are crystalline carbon having a hollow cylindrical structure, and are heating bodies that generate heat when current flows therethrough. The carbon nanotubes are distributed so as to extend throughout each portion of the heating layer 26. There is a change (rise) in the resistance value of the heating layer 26 when damage such as a crack or the like occurs in part of the carbon nanotube film 24, however current still flows in portions where damage has not occurred.

The pair of electrodes 28 are each a bus-bar formed in an elongated thin strip shape using a conductive material. The pair of electrodes 28 form a pair opposing each other along the in-plane direction along the surface of the carbon nanotube film 24 (namely, the surface of the heating layer 26), and the two end portions thereof in the in-plane direction thereof are respectively connected to the heating layer 26.

As illustrated in FIG. 2, the control ECU 30 is configured including a central processing unit (CPU) 30A, read only memory (ROM) 30B, random access memory (RAM) 30C, storage 30D, a communication I/F 30E, and an input-output I/F 30F. The CPU 30A, the ROM 30B, the RAM 30C, the storage 30D, the communication I/F 30E, and the input-output I/F 30F are connected together through a bus 30G so as to be able to communicate with each other.

The CPU 30A is a central processing unit that executes various programs and controls each section. Namely, the CPU 30A reads a program from the ROM 30B, and executes the program using the RAM 30C as a work area. In the present exemplary embodiment a program is stored in the ROM 30B. The control ECU 30 of the heater device 20 functions as a detection unit 38, a power supply control unit 36, and a notification unit 40 illustrated in FIG. 3 by the CPU 30A executing the program.

The ROM 30B is stored with various programs and various data. The RAM 30C serves as a work area for temporarily storing programs or data. The storage 30D is configured by a hard disk drive (HDD) or a solid state drive (SSD), and stores various programs including an operating system. The communication I/F 30E includes an interface for communication with a user mobile terminal 32 over a network. The interface uses, for example, a communication standard such as LTE, Wi-Fi (registered trademark), or the like.

A display 34 installed to a vehicle, and the planar heaters 22A, 22B, 22C are each individually connected by wire to the input-output I/F 30F. The display 34 and the mobile terminal 32 correspond to a “user interface” of the present disclosure. Note that the display 34 and the planar heaters 22A, 22B, 22C may be directly connected to the bus 30G.

The control ECU 30 includes, as functional configuration as described above, the power supply control unit 36, the detection unit 38, and the notification unit 40 as illustrated in FIG. 3. These functional configurations are implemented by the CPU 30A reading out and executing a program stored in the ROM 30B.

The power supply control unit 36 includes a function to perform control of a power source supply to the planar heaters 22A, 22B, 22C based on detection results of the detection unit 38 and the like. The power supply control unit 36 starts power supply to the planar heaters 22A, 22B, 22C on operation of a non-illustrated heater switch or the like provided in the vehicle seat 10.

The detection unit 38 includes a function to detect heating abnormalities of the planar heaters 22A, 22B, 22C. The detection unit 38 is configured to detect a magnitude of a voltage applied to the planar heaters 22A, 22B, 22C using the power supply control unit 36. The detection unit 38 is also configured to detect a magnitude of current flowing in the planar heaters 22A, 22B, 22C by, for example, using a current detection resistor (omitted in the drawings) connected to the input-output I/F 30F. Furthermore, the detection unit 38 is configured to detect an electrical resistance of the planar heaters 22A, 22B, 22C based on these voltages and currents. The detection unit 38 detects heating abnormalities and their degree individually for the planar heaters 22A, 22B, 22C based on the respective electrical resistances of the planar heaters 22A, 22B, 22C.

Note that the detection unit 38 may be configured to detect heating abnormalities of the planar heaters 22A, 22B, 22C based on the temperatures of the planar heaters 22A, 22B, 22C. In such cases a configuration is adopted in which a temperature sensor for detecting a temperature of the planar heaters 22A, 22B, 22C is connected to the input-output I/F 30F.

The notification unit 40 includes a function to notify an occupant that a heating abnormality has occurred in the planar heaters 22A, 22B, 22C. When a heating abnormality has been detected in the planar heaters 22A, 22B, 22C by the detection unit 38, the notification unit 40 displays content regarding the abnormality on the display 34 and the mobile terminal 32. Specifically, when a heating abnormality has been individually detected in the planar heaters 22A, 22B, 22C by the detection unit 38, each abnormality is individual notified to the occupant using the display 34 and the mobile terminal 32. Namely, for example, in a case in which a heating abnormality has occurred in the planar heater 22A, the notification unit 40 displays an image on the display 34 and the mobile terminal 32 to indicate that a heating abnormality has occurred in the heater of the seat cushion 14.

Moreover, the notification unit 40 displays on the display 34 and the mobile terminal 32 the magnitude of the voltages applied to the planar heaters 22A, 22B, 22C, the magnitude of the current flowing in the planar heaters 22A, 22B, 22C, and the electrical resistances of the planar heaters 22A, 22B, 22C. Moreover, the notification unit 40 uses the display 34 and the mobile terminal 32 to notify the occupant of the degree of abnormality detected for the planar heaters 22A, 22B, 22C based on electrical resistance as detected by the detection unit 38 for the planar heaters 22A, 22B, 22C. Namely, for example, the notification unit 40 displays on the display 34 and the mobile terminal 32 an image quantitatively indicating such a degree, using a graph or the like. Furthermore, the notification unit 40 displays on the mobile terminal 32 and the display 34 an image indicating a temperature distribution of the seat main body 12 when utilized without repairing the heater device 20 and a temperature distribution prior to the abnormality occurring, in a mode that enables comparison therebetween. Note that in cases in which the temperature sensors for detecting the temperatures of the planar heaters 22A, 22B, 22C are connected to the input-output I/F 30F, the notification unit 40 displays the temperatures of the planar heaters 22A, 22B, 22C on the display 34 and the mobile terminal 32.

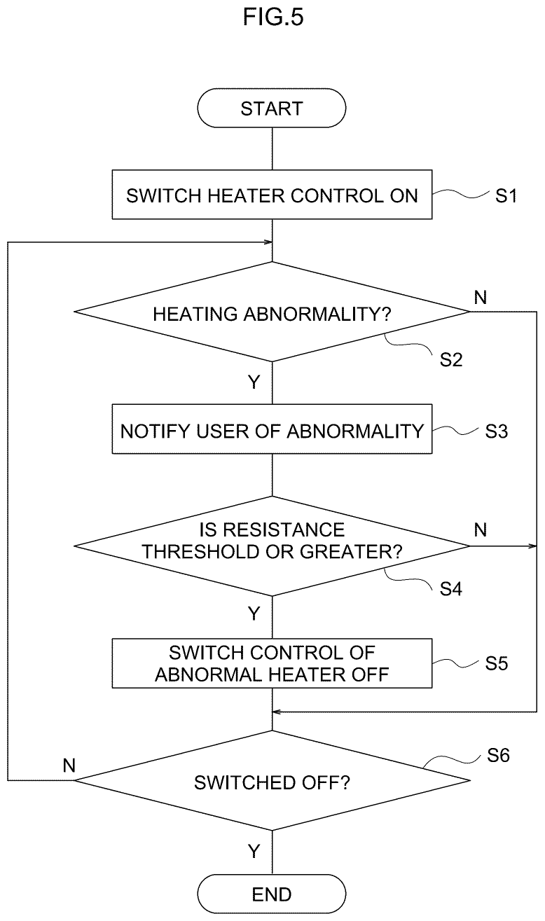

Description follows regarding a flow of control processing executed by the CPU 30A of the control ECU 30, with reference to FIG. 5. In the following description the planar heaters 22A, 22B, 22C are sometimes referred to as “planar heaters 22”. First, when the heater switch provided in the vehicle seat 10 or the like is switched ON, at step S1 of FIG. 5, the CPU 30A starts power supply to the planar heaters 22A, 22B, 22C. A voltage is thereby applied across the pair of electrodes 28 for each of the planar heaters 22A, 22B, 22C, and the heating layer 26 in each of the planar heaters 22A, 22B, 22C is heated. Processing next transitions to step S2 when the processing of step S1 is complete.

At step S2, the CPU 30A functions as the detection unit 38 and determines whether or not a heating abnormality has occurred in the planar heaters 22A, 22B, 22C. Processing transitions to the next step S3 when affirmative determination is made, and processing transitions to step S6 when negative determination is made.

At step S3, the CPU 30A functions as the notification unit 40 and uses the mobile terminal 32 and the display 34 to notify the occupant of a heating abnormality of the planar heaters 22A, 22B, 22C. Specifically, when a heating abnormality has occurred in any of the planar heaters 22 from out of the planar heaters 22A, 22B, 22C, the CPU 30A displays details regarding the abnormality (namely, the voltage, current, and electrical resistance of the planar heater in which an abnormality has occurred), and the degree of the abnormality, on the display 34 and the mobile terminal 32. Processing transitions to the next step S4 when the processing of step S3 has been completed.

At step S4, the CPU 30A functions as the detection unit 38 and determines whether or not the resistance value of the planar heater 22 where the abnormality has occurred is a threshold or greater (namely, whether or not the degree of abnormality is severe). Processing transitions to the next step S5 when affirmative determination is made, and processing transitions to step S6 when negative determination is made.

At step S5, the CPU 30A stops power supply to the planar heater in which an abnormality has occurred, and ends the control of this planar heater. This thereby enables a fire or the like to be prevented from occurring due to the planar heater in which an abnormality has occurred continuing to be used. Processing transitions to next step S6 when the processing of step S5 is complete.

At step S6, the CPU 30A determines whether or not the heater switch has been switched OFF. The control processing by the CPU 30A is ended when affirmative determination is made. However, processing returns to step S2 and the processing described above is repeated when negative determination is made at step S6. In such cases, the CPU 30A continues to control the planar heaters 22 because determination is either that no heating abnormality has occurred in the planar heater 22, or that even if an abnormality has occurred any of the planar heaters 22, the degree of the abnormality has been determined to be a slight abnormality.

Next, description follows regarding the operation and advantageous effects of the present exemplary embodiment.

In the present exemplary embodiment, the planar heaters 22A, 22B, 22C each include the heating layer 26 with the uniformly disposed carbon nanotubes therein. If part of any of these planar heaters 22 is damaged and a heating abnormality occurs in this part, then the abnormality is detected by the detection unit 38 of the control ECU 30, and also the notification unit 40 of the control ECU 30 notifies an occupant of the abnormality using the mobile terminal 32 and the display 34. This thereby enables prompting of the occupant to inspect and repair the heater device 20, and so contributes to the prevention of an abnormality from being left unattended. As a result thereof, damage of the planar heater 22 can be prevented from spreading, enabling the damage to the planar heater 22 to be repaired while still small.

In particular, there are sometimes cases in the heater device 20 of the vehicle seat 10 in which, even if abnormal heating has occurred to part of the planar heater 22, the temperature of the surface of the seat main body 12 still attains saturation due to a normal temperature being maintained for other portions thereof. In such cases there is only a small temperature difference between the temperature normally and during an abnormality, making it difficult for an occupant to notice the abnormality. There is accordingly a concern that damage (cracking or the like) might spread in the planar heater 22 were the abnormality to be left unattended as a result, and so preferably an occupant is notified of the abnormality by control of the heater device 20. Moreover, in the present exemplary embodiment, due to use of the heater device 20 not being stopped immediately, inconvenience can be avoided from being caused to an occupant, in particular in a cold region.

Moreover, in the present exemplary embodiment, the detection unit 38 is configured to detect the electrical resistance of the planar heaters 22, the voltage applied to the planar heaters 22, and the current flowing in the planar heaters 22, and in a case in which an abnormality of the planar heaters 22 has been detected by the detection unit 38, and the notification unit 40 displays on the mobile terminal 32 and the display 34 the electrical resistance, voltage, and current of the planar heater 22 where an abnormality has occurred. This thereby enables details regarding the abnormality of the planar heater 22 to be notified to the occupant and so, for example, makes it easier for the occupant to guess the cause of the abnormality.

Moreover, in the present exemplary embodiment, the detection unit 38 is configured to detect the degree of abnormality of the planar heater 22 based on the electrical resistance of the planar heater 22. The notification unit 40 displays an image making the degree of the abnormality apparent on the mobile terminal 32 and the display 34 in a case in which an abnormality of the planar heater 22 has been detected by the detection unit 38. The occupant is accordingly able to ascertain the degree of the abnormality of the planar heater 22 and, for example, the occupant is able to determine whether or not there is a need to immediately repair the heater device 20.

Moreover, in the present exemplary embodiment, the heater devices 20 include the plural planar heaters 22A, 22B, 22C, and the detection unit 38 is configured to individually detecting the occurrence of a heating abnormality in the plural planar heaters 22A, 22B, 22C. The notification unit 40 then uses the mobile terminal 32 and the display 34 to notify the occupant individually of abnormalities of the planar heaters 22 as detected individually by the detection unit 38. This thereby enables an occupant to ascertain whether an abnormality has occurred in whichever of the planar heaters 22 from out of the plural planar heaters 22A, 22B, 22C (namely, which heater from out of the seat cushion 14 or the seatback 16 the abnormality has occurred in).

Note that although the above exemplary embodiment is a configuration in which the heater device 20 is provided to the vehicle seat 10, there is no limitation thereto, and the heater device according to the present disclosure may be provided to clothing, a non-vehicular chair, or the like.

Various modifications may be implemented in the present disclosure within a range not departing from the spirit thereof. Moreover, obviously the scope of rights of the present disclosure is not limited to the above exemplary embodiment.

The entire content of the disclosure of Japanese Patent Application No. 2022-207317 filed on Dec. 23, 2022 is incorporated by reference in the present specification. All publications, patent applications and technical standards mentioned in the present specification are incorporated by reference in the present specification to the same extent as if each individual publication, patent application, or technical standard was specifically and individually indicated to be incorporated by reference.

1. A heater device, comprising:
a planar heating element including a heating layer in which a carbon material is uniformly dispersed;
a detection unit configured to detect a heating abnormality of the planar heating element; and
a notification unit that, in a case in which an abnormality has been detected by the detection unit, notifies a user of the abnormality using a user interface.

2. The heater device of claim 1, wherein:
the detection unit is configured to detect at least one of an electrical resistance of the planar heating element, a voltage applied to the planar heating element, a current flowing in the planar heating element, or a temperature of the planar heating element; and
the notification unit uses the user interface to notify a user of the at least one in a case in which an abnormality has been detected by the detection unit.

3. The heater device of claim 1, wherein:
the detection unit is configured to detect a degree of an abnormality based on an electrical resistance of the planar heating element; and
the notification unit notifies a user of the degree of the abnormality using the user interface in a case in which an abnormality has been detected by the detection unit.

4. The heater device of claim 1, wherein:
a plurality of the planar heating elements are provided;
the detection unit is configured to individually detect heating abnormalities of the plurality of planar heating elements; and
the notification unit uses the user interface to individually notify the user of the abnormalities individually detected by the detection unit.

5. A vehicle seat, comprising:
a seat main body including a seat cushion for an occupant of a vehicle to sit on and a seatback to support the back of the occupant; and
the heater device of claim 1 or claim 2, having the planar heating element disposed in the seat main body.
